(19) United States
(12) Patent Application Publication
(10) Pub. No.: US 2010/0017134 A1
(43) Pub. Date: Jan. 21, 2010

(54) GRAVEL PACK ASSESSMENT TOOL AND METHODS OF USE

(75) Inventors: Donald K. Steinman, Missouri City, TX (US); Russel C. Hertzog, Georgetown, TX (US); John E. Smaardyk, Kingwood, TX (US)

Correspondence Address: HAYNES AND BOONE, LLP;IP Section, 2323 Victory Avenue, Suite 700, Dallas, TX, 75219, US

(73) Assignee: WOOD GROUP LOGGING SERVICES, INC.

(21) Appl. No.: 12/496,163

(22) Filed: Jul. 1, 2009

Related U.S. Application Data
(60) Provisional application No. 61/133,771, filed on Jul. 2, 2008.

(51) Int. Cl. G01V 5/04; E21B 47/00; G01T 3/06

(52) U.S. Cl. 702/8; 73/152.54; 250/363.01; 250/260; 250/261

(57) ABSTRACT

A gravel pack evaluation tool comprised of a low energy radiation source and multiple directionally-collimated radiation detectors to analyze small, azimuthal segments of a gravel pack. Methods of use are also provided. Collimators and radiation shielding used in conjunction with multiple detector arrays allow an azimuthal segmented view of a gravel pack, particularly at certain defined depths into a gravel pack. Radioactive tracers may be used in conjunction with these tools to produce enhanced images of gravel packs and formations.

### CROSS-REFERENCE TO RELATED APPLICATION

The present application is a nonprovisional patent application that claims priority to and the benefit of U.S. Provisional Application Ser. No. 61/133,771, filed Jul. 2, 2008, which is hereby incorporated by reference.

### BACKGROUND

The present application relates to downhole tools for evaluating gravel packs in well completions. More particularly, methods and devices are provided for evaluating discrete portions of the gravel pack adjacent a screen using a downhole gravel pack imaging tool.

Hydrocarbon wells are often located in subterranean formations that contain unconsolidated particulates that may migrate out of the subterranean formation with the oil, gas, water, and/or other fluids produced by the wells. The presence of particulates, such as formation sand, in produced fluids is undesirable in that the particulates may abrade pumping and other producing equipment, such as tubing, pumps, and valves. Additionally, the particulates may partially or fully clog the well thus reducing the fluid production capabilities of the producing zones, creating the need for an expensive remedial workover. Also, if the particulates are produced to the surface, they must be removed from the hydrocarbon fluids using surface processing equipment.

One method for preventing the production of such particulates in unconsolidated or weakly consolidated formations is to gravel pack the well adjacent to the unconsolidated or loosely consolidated production intervals. In a typical gravel pack completion, a perforated base pipe is positioned in the wellbore proximate the desired formation production interval. Disposed around the perforated base pipe is wire wrap or screen having spacing therein. A relatively coarse particulate material, such as sand, gravel, or proppants, which are typically sized and graded and collectively referred to as “gravel,” is disposed in the wellbore annulus between the screen and the wellbore. The screen is sized to permit formation fluid to flow through the screen while maintaining the gravel pack in place around the screen. Likewise, the size of the gravel in the pack is selected such that it prevents formation fines and sand from flowing into the wellbore with produced fluids.

In this way, the gravel pack presents a physical barrier to the transport of unconsolidated formation fines with the production of hydrocarbons. Accordingly, gravel packs perform the desired function of mitigating sand or fines production.

The performance of a gravel pack depends in part on the distribution and density of the gravel pack, particularly around the screen. Over time, both distribution and density of the pack can degrade, for various reasons. For example, the performance of gravel packs can be impaired by plugging if particles become trapped in the screen openings, which in turn reduces the permeability of the screen and therefore, well productivity. Sometimes, the gravel constituting a gravel pack becomes non-uniformly distributed during production due to downhole conditions such as non-uniform flow rates downhole. Additionally, during the placement of a gravel pack, void areas may result causing undesirable non-uniformity of the gravel pack. Voids and inconsistencies may also form over time due to hydrocarbon flow from the formation through the pack. Such maldistributions of gravel in the gravel pack adversely affect the ability of the gravel pack to optimally perform its function of particulate mitigation. Such problems are exacerbated even more in deviated and horizontal wells as the force of gravity contributes to producing void areas and maldistributions in the gravel pack. Moreover, it has been determined that these problems are often particularly acute adjacent the screen. While voids in the gravel pack at locations removed from the screen may not inhibit fines passing through the gravel pack to the same degree as a more dense gravel pack, voids adjacent the screen permit particles to reach the screen more readily so as to increase the possibility of screen plugging as described above.

Therefore, it is desirable to effectively evaluate gravel packs for uniformity, density and porosity adjacent the screens. Effective and accurate evaluation of a gravel pack adjacent the screen allows operators to determine whether the gravel pack is performing at a desired capacity or whether remedial action such as a workover operation is required.

Conventional methods for evaluating gravel packs include formation evaluation tools such as radioactive source/detector tools which utilize a radioactive source to propagate energy into the gravel pack. Examples of such conventional tools include Schlumberger's Memory Gravel Pack Logging tool (MGLT), Titan's Gravel Pack Logging Density tool, Robertson's rotating neutron shield tool as described in U.S. Pat. No. 5,481,105 (means of obtaining azimuthal measurement discrimination provided by a rotating neutron shield). Although neutron sources have been used in tool designs such as the MGLT tool, they suffer from poor spatial-resolution capability. Neutron-capture generated gamma rays may be used such as in Titan's Gravel Pack Logging Density tool, but issues prevail with detecting and interpreting gravel/sand signature in the presence of high-saline completion fluids. Other types of radiation such as X-rays do not have sufficient penetrating capability to provide desired gravel pack imaging.

Conventional methods for evaluating gravel packs, however, are utilized to evaluate the entire gravel pack instead of discrete portions of the gravel pack, such as the gravel pack directly adjacent the screen. Since gravel packs are typically about 3 to about 8 inches in diameter, such conventional methods must utilize a fairly high energy source which is capable of propagating energy to the outer diameter of the gravel pack. As such, conventional methods for evaluating gravel packs are limited in their ability to focus on discrete segments of the gravel pack and instead view the gravel pack as a whole, such as, for example, utilizing an omnidirectional energy source and a single detector positioned on the perimeter of the tool string at a location removed from the source.

Conventional neutron-based gravel pack tools do not have a capability for spatial discrimination, and focused gamma-based tools do not have azimuthal spatial resolution (i.e. “imaging capabilities”) unless they are mechanically rotated while in the well.

Heretofore, no tool has been developed that can investigate and evaluate the discrete area of gravel pack adjacent the screen. Additionally, many of the conventional tools fail to gather information regarding the integrity of a gravel pack during a single pass through a well bore.

### SUMMARY

The present application relates to downhole tools for evaluating formations and gravel packs. More particularly, methods and devices are provided for evaluating discrete portions of the gravel pack adjacent a screen using a downhole gravel pack imaging tool.

The tool provides density-based data on longitudinal sand and gravel distributions with a radial component to look behind the screen to provide information on the distribution of the sand. The tool can be used yield a base log on a new gravel pack to evaluate initial gravel and sand distributions. The tool can also be used with other measurements to identify location of gravel erosion and sand entry.

An example of a method for evaluating a gravel pack disposed in a completed wellbore comprises the steps of: providing a downhole evaluation tool comprising a radiation source, an array or a plurality of detectors for measuring radiation so as to produce measured radiation data, a source collimator for directionally constraining radiation from the radiation source to a limited segment of the gravel pack, detector shielding for each detector that results in a limited view for each detector to an azimuthal segment of the gravel pack, and electronics communicatively coupled to the array or plurality of detectors for receiving the measured radiation data; raising the downhole evaluation tool in a wellbore; allowing the radiation source to emit radiation focused on a segment of the gravel pack; measuring radiation via the detectors to produce measured radiation data; and analyzing the measured radiation data to assess integrity of the gravel pack.

An example of a gravel pack imaging tool for evaluating gravel pack integrity comprises a housing; a radiation source disposed in the housing; a source collimator disposed adjacent the radiation source; a detector collimator defined along an axis and disposed in the housing; and an array or plurality of detectors, each detector characterized by a collimated view and each detector mounted spaced apart from one another on said collimator.

An example of a gravel pack imaging tool for evaluating gravel pack integrity comprises a housing; a radiation source disposed in the housing; a source collimator disposed adjacent the radiation source wherein said source collimator is conical in shape; and a detector disposed in the housing said detector mounted spaced apart from said source.

The features and advantages of the present invention will be apparent to those skilled in the art. While numerous changes may be made by those skilled in the art, such changes are within the spirit of the invention.

### BRIEF DESCRIPTION OF THE DRAWINGS

A more complete understanding of the present disclosure and advantages thereof may be acquired by referring to the following description taken in conjunction with the accompanying figures, wherein:

FIG. 1 illustrates a simplified schematic diagram of low energy radiation source and a plurality of detectors disposed in a wellbore in a downhole imaging tool for evaluation of a gravel pack or formation adjacent a screen.

FIG. 2 illustrates a perspective view of one embodiment of a gravel pack imaging tool.

FIGS. 3A and 3B show cross-sectional views of another embodiment of the tool illustrated in FIG. 2, taken from the indicated X-Y and X-Z planes.

FIG. 4 shows a graph of a source response in a gravel pack.

FIG. 5 shows a graph of a count rate versus depth in centimeters as measured by a 3.5″ gravel-pack imaging tool in a 7 inch gravel pack.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DESCRIPTION OF PREFERRED EMBODIMENTS

The present application relates to downhole tools for evaluating formations and gravel packs. More particularly, methods and devices are provided for evaluating discrete portions of the gravel pack adjacent a screen using a downhole gravel pack imaging tool.

Methods and devices of the present invention allow for evaluation of the integrity of discreet portions of a gravel pack immediately adjacent a downhole tool, such as those portions of the gravel pack immediately adjacent the production screen. As used herein, the term “integrity” refers to the uniformity, density, and other characteristics of the gravel pack that affect the porosity and permeability thereof. Voids or vugs in the gravel pack are undesirable to production of hydrocarbons and well life, and it is desirable to determine the location any such voids or vugs prior to or during production from the well so that they may be repaired and thus enhance production from the well.

In certain embodiments, downhole imaging tools of the present invention comprise a gamma ray radiation source, a source collimator for directionally constraining radiation from the radiation source to a longitudinal segment of the gravel pack, a plurality of detectors for measuring primarily single-scattered radiation returned from the gravel pack so as to produce measured azimuthally oriented radiation data, a detector shielding or collimator for each detector that results in a limited view for each detector to an azimuthal segment of the gravel pack, and electronics communicatively coupled to the plurality of detectors for receiving the measured radiation data and processing said data into information about the status of the gravel pack. Radioactive tracers may be used in conjunction with certain embodiments to produce enhanced images of the gravel pack.

Advantages of certain embodiments include, but are not limited to, the ability to independently assess the integrity of discrete segments or portions of a gravel pack, the ability to assess the integrity of the gravel pack immediately adjacent the gravel pack screen, and the ability to assess the integrity of the gravel pack as a function of depth or distance from the downhole imaging tool. Other advantages include, but are not limited to, the ability to determine which part of a gravel-pack assembly is defective, e.g., shunt clogging or bridging effects, voids in the gravel pack, scale buildup in the gravel pack, and other impediments to production of hydrocarbons from the well.

While the specific embodiments below discuss assessment tools of the present invention with respect to assessment of gravel packs, it is explicitly recognized that the assessment tools herein may be used to image, assess, or otherwise determine the location of stuck pipe. The stuck pipe situation is analogous to the gravel pack case in which the gravel pack base pipe/screen combination is replaced by the stuck drill pipe. The gravel pack imaging tool can then image any material, such as sand or piece of formation rock, lodged between the drill pipe and formation or casing that has caused the drill pipe to become stuck. In this way, certain embodiments of the present invention may be used to locate places where a drill pipe has become stuck in the well. Knowing such locations and environments can assist drilling operations in removing stuck pipe so as to reduce the cost of further drilling.

To facilitate a better understanding of the present invention, the following examples of certain embodiments are given. In no way should the following examples be read to limit, or define, the scope of the invention.

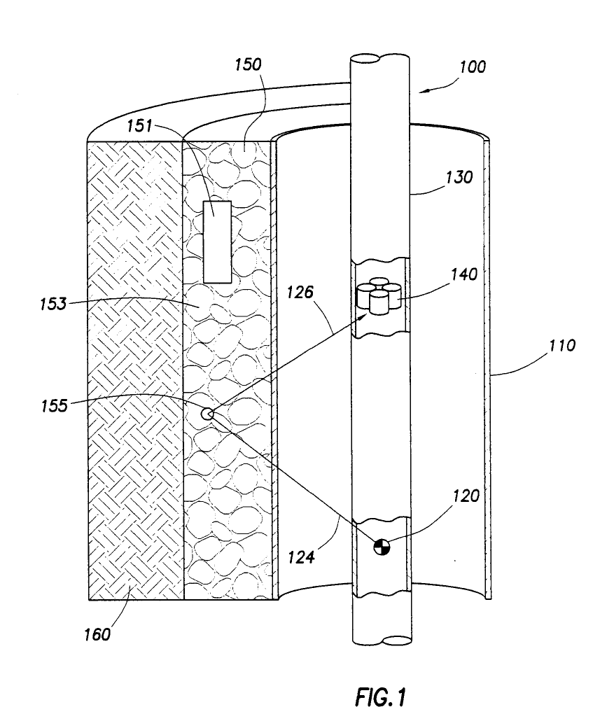

As a brief overview of the mechanism of operation of the present invention, FIG. 1 illustrates a simplified schematic diagram of radiation source and an array or a plurality of detectors disposed in a wellbore in a downhole imaging tool for evaluation of a gravel pack or formation.

In FIG. 1, a downhole imaging tool 100 is shown positioned in a “base-pipe” or inner steel housing 110 of a gravel pack. It is recognized that a tool housing 130 may be constructed of any light metal wherein the term, “light metal,” as used herein, refers to any metal having an atomic number less than 23. Downhole imaging tool 100 comprises at a minimum a housing or pipe 130 carrying a low energy radiation source 120 and plurality of detectors 140. Gamma radiation source 120 is preferably centrally located in housing 130. Likewise, detectors 140 are preferably symmetrically spaced apart azimuthally at a constant radius, but also positioned within housing 130. In other words, the radius on which detectors 140 are spaced apart is preferably less than the radius of the housing 130. Radiation source 120 emits radiation, in this case, gamma rays 124 into gravel pack 150.

The alternating hatching of gravel pack 150 indicates possible regions of gravel pack that could be gravel-filled or not. For example, center region 151 may constitute a void in gravel pack 150 that has been filled with completion fluids or production fluids whereas other regions 153 may constitute portions of the gravel pack that are properly completed or filled in. Of course, those skilled in the art, with the benefit of this disclosure, will appreciate that the foregoing regions are for illustrative purposes only and that a void or vug could take any shape and any position relative to tool 100.

As illustrated, gamma rays 124 propagating into gravel pack 150 are Compton scattered (as at point 155), with a loss of some energy, back towards detectors 140 located within downhole imaging tool 100. Upon scattering the gamma rays, they become lower energy gamma rays 126, which are detected by detectors 140. The count-rate intensity of Compton scattered gamma rays 126 depends on, among other factors, the density of the gravel pack material. Hence, higher count rates represent higher density in the gravel pack, whereas lower count-rates represent lower density as a result of fewer gamma rays being back-scattered towards the detectors.

Preferably, radiation source 120 is barium, cesium or some other low energy radiation source. By utilizing a low energy source such as this, energy is only propagated a short distance into the gravel pack immediately adjacent a screen. For this same reason, detectors 140 must be positioned in housing 130 close to radiation source 120. In one preferred embodiment, radiation source 120 and detectors 140 are no more than about 3 to about 3.5 inches apart along the length of tool 100.

Shielding (not shown in FIG. 1) may be applied around radiation source 120 to collimate or otherwise limit the emission of radiation from radiation source 120 to a limited longitudinal segment of gravel pack 150. In one preferred embodiment, such shielding is a heavy metal shield, such as sintered-tungsten, which collimates the pathway for the emitted gamma rays into the gravel pack. Likewise, as described in more detail below, similar shielding may be used around each detector to limit the detector viewing aperture to only those gamma rays that are primarily singularly scattered back to the detector from a specific azimuthal section of the gravel pack.

Further, the energy levels of the emitted gamma rays 124 may be selected to assess gravel pack density at varying depths or distances from downhole imaging tool 100. As one example, the radiation from a low-energy gamma ray source, such as a ¹³³Ba source, may be used to emit various energy levels. Alternatively, a gamma ray radiation source with an energy close to that of ¹³⁷Cs may be used.

Techniques for converting radiation count rates into a complete 2D profile map of the gravel pack integrity include the SYSTAT's Table Curve 3D method. Other techniques include, but are not limited to, MATLAB, IMAGE, and advanced registration and techniques for making mosaic representations from data points can be used to map the base-pipe and gravel-pack environment. Also, 3D geostatistical-based software can be adapted to convert the basic gamma-ray count rates to generate a map of the gravel-pack environment. In this way, the integrity of a gravel pack or formation may be determined.

To produce accurately oriented maps, it is preferred to determine the azimuthal angle of the logging tool relative to the high side of the borehole. This orientation can be determined using any orientation device known in the art. Orientation devices may contain one or more orientation sensors used to determine orientation of the logging tool with respect to a reference plane. Examples of suitable orientation devices include, but are not limited to, those orientation devices produced by MicroTesla of Houston, Tex. Each set of gamma ray measurements may be associated with such an orientation so that a 2D profile map of the gravel pack can be accurately generated in terms of the actual azimuthal location of the material in the gravel pack.

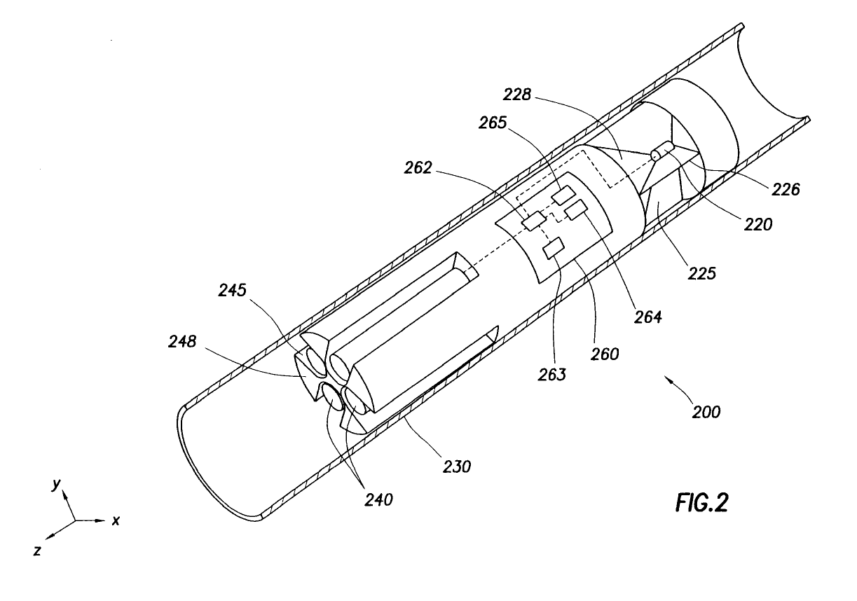

FIG. 2 illustrates a perspective view of one embodiment of a gravel pack imaging tool. As shown, downhole imaging tool 200 of the present invention comprises a housing 230 which carries radiation source 220, source collimator 225, and a plurality of radiation detectors 240 in an array. The array of detectors 240 may be positioned at a fixed distance from radiation source 220. In certain embodiments, detector arrays may be positioned at differing distances from radiation source 220. Additionally, detector arrays on either side of radiation source 220 is also envisioned in certain embodiments. Electronics 260 may also be located in housing 230 or wherever convenient.

Radiation source 220 may be one or more radiation sources, which may include any suitable low-energy gamma ray source capable of emitting gammy ray radiation from about 250 keV to about 700 keV. Gamma ray sources suitable for use with embodiments of the present invention may comprise any suitable radioactive isotope including, but not limited to, radioactive isotopes of barium, cesium, a LINAC, high energy X-rays (e.g. about 200+ keV), or any combination thereof. Radiation from radiation source 220 may be continuous, intermittent, periodic, or in certain embodiments, amplitude, frequency, phase modulated, or any combination thereof.

Radiation source 220 is preferably centrally located in housing 230. In the illustrated embodiment, source 220 is positioned along the axis of housing 230.

Collimator 225, which is optional in certain embodiments, may be-configured adjacent to the source 220 in order to directionally constrain radiation from the radiation source 220 to an azimuthal radiation segment of the gravel pack. For example, collimator 225 may include fins or walls 226 adjacent source 220 to direct gamma ray propagation. By directing, focusing, or otherwise orienting the radiation from radiation source 220, radiation may be guided to a more specific region of the gravel pack. It is appreciated that in certain embodiments, a heavy-met shutter mechanism could be further employed to direct radiation from radiation source 220. Additionally, the radiation energy may be selected, by choosing different isotopic sources, so as to provide some lithological or spatial depth discrimination.

In the illustrated embodiment, collimator 225 constrains radiation from source 220. In this embodiment, collimator 225 is also conically shaped as at 228, in the direction of detectors 240 to collimate the gamma rays from source 220. Of course, those skilled in the art will appreciate that collimator 225 may be configured in any geometry suitable for directing, focusing, guiding, or otherwise orienting radiation from radiation source 220 to a more specific region of the gravel pack.

The radiation transmitted from source 220 into a gravel pack (such as gravel 150 of FIG. 1) is then Compton scattered back from the gravel pack to tool 200 where the back-scattered radiation may be measured by radiation detectors 240. Radiation detectors 240 are any plurality of sensors suitable for detecting radiation, including gamma ray detectors. In the illustrated embodiment, four detectors are depicted, although any number of detectors can be utilized. In another preferred embodiment, three detectors or six detectors are utilized. In any event, each detector is disposed to “view” a different segment of the gravel pack. Most desirably, with multiple detectors, the tool can image the entire circumference of the gravel pack in separately identifiable segments. The resolution of the image of the overall circumference will depend on the number of detectors, the energy of the gamma rays and the degree of shielding provided around each detector.

In certain embodiments, gamma ray detectors may comprise a scintillator crystal, where such crystals emit light that is proportional to the energy deposited in the crystal by each gamma ray. A photomultiplier tube coupled to the crystal converts the light from the scintillation crystal to measurable electron current or voltage pulse, which is then used to quantify the energy of each detected gamma ray. In other words, the gamma rays are quantified, counted, and used to estimate the density of the gravel pack adjacent a screen. Photomultiplier tubes may be replaced with high-temperature charge-coupled device (CCD) or micro-channel photo-amplifiers. Examples of suitable scintillator crystals that may be used include, but are not limited to, NaI crystals, NaI(Tl), BGO, and Lanthanum-bromide, or any combination thereof. In this way, count-rates may be measured from returned radiation, in this case, returned gamma rays. The intensity of the Compton scattered gamma rays depends on, among other factors, the density of the gravel pack material. Hence, lower density represents gaps in the gravel pack and lower count-rates represent lower density as a result of fewer gamma rays being back-scattered towards the detectors.

Detectors 240 are preferably mounted inside a housing at a radius smaller than the radius of housing 230. In other words, detectors 240 are inset from the surface of housing 230. Likewise, while they need not be evenly spaced, in the illustrated embodiment, detectors 240 are evenly spaced on the selected radius. Although the illustrated example shows four detectors 240 spaced apart 90 degrees from one another, those skilled in the art will appreciate that any number of multiple detectors can be utilized in the invention. Further, while the embodiment illustrates all of the detectors 240 positioned at the same distance from source 220, they need not be evenly spaced. Thus, for example, one detector (or a multi-detector array) might be spaced apart 12 centimeters from the source, while another detector (or a detector array) is spaced apart 20 centimeters from the source or any other distance within the tool.

Similarly, in another embodiment, detectors 240 can be positioned both above and below source 220. In such a case, collimator 225 would be appropriately shaped to guide gamma rays in the direction of the desired detectors. In such embodiments with multiple detectors disposed on both sides of the radiation source, additional shielding may be provided between the collimators to prevent radiation scattering (i.e. cross-contamination of the radiation) from different segments of the gravel pack.

Each detector 240 is mounted so as be shielded from the other detectors 240. While any type of shielding configuration may be utilized for the detectors 240, in the illustrated embodiment, collimator 248 is provided with a plurality of openings or slots 245 spaced apart around the perimeter of collimator 248. Although openings 245 could have any shape, such as round, oval, square or any other shape, in the preferred embodiment, openings 245 are shaped as elongated slots and will be referred to as such herein.

A detector 240 is mounted in each slot 245, so as to encase detector 240 in the shield. The width and depth of the slot 245 can be adjusted as desired to achieve the desired azimuthal range. In certain embodiments, it is desirable that the length of slots 245 be as long as the sensitive region of the gamma-ray detector (e.g. the crystal height). It will be appreciated that since a detector is disposed within the slot, the detector is not on the surface of the collimator where it might otherwise detect gamma rays from a larger azimuthal range. In one preferred embodiment, slot 245 is 360/(number of detectors) degrees wide and the detector face to inner diameter of the pressure housing is a few millimeters deep (e.g. from about 2 to about 5 mm). However, tighter collimation is possible. Preferably, the azimuthal range of each slot is limited to 360/(number of detectors) degrees. In this way, the view of each radiation detector 240 may be more focused on a particular region of the gravel pack. Additionally, such shielding eliminates or at least mitigates radiation scattered from one detector to another detector. As can be seen, each detector is separated from one another by radiation absorbent material. By eliminating detector-to-detector radiation scattering, more precise azimuthal readings are achieved.

While source collimator 225 is shown as a single, integrally formed body, having fins 226, conical surface 228, it need not be and could be formed of separate structural components, such as a source collimator combined with a detector collimator 248, so long as the shielding as described herein is achieved.

In the illustrated embodiment, the region of housing 230 around the opening in source collimator and detectors 240 is fabricated of beryllium, aluminum, titanium, or other low atomic number metal or material, the purpose of which is to allow more of the gamma rays to enter detectors 240. This design is especially important for lower energy gamma rays, which are preferentially absorbed by any dense metal in the pressure housing.

Alternatively, or in addition to detector shielding or collimator 248, an anti-coincidence algorithm may be implemented in electronics 260 to compensate for detector-to-detector radiation scattering. In this way, a processor can mitigate the effects of multiply-detected gamma rays via an anti-coincidence algorithm. In certain embodiments, electronics 260, 262, and 264 are preferably located above detectors 240 or below source 220.

Electronics 260 comprise processor 262, memory 263, and power supply 264 for supplying power to gravel pack imaging tool 200. Power supply 264 may be a battery or may receive power from an external source such as a wireline (not shown). Processor 262 is adapted to receive measured data from radiation detectors 240. The measured data, which in certain embodiments comprises count rates, may then be stored in memory 263 or further processed before being stored in memory 263. Processor 262 may also control the gain of the photomultiplier or other device for converting scintillations into electrical pulses. Electronics 260 may be located below source 220 and above detectors 240 or removed therefrom.

In one preferred embodiment, the tool further includes an accelerometer, a 3 axis inclinometer or attitude sensor to unambiguously determine the position of an azimuthal segment. In certain embodiments, a compass device may be incorporated to further determine the orientation of the tool.

Gravel pack imaging tool 200 may be constructed out of any material suitable for the downhole environment to which it is expected to be exposed, taking into account in particular, the expected temperatures, pressures, forces, and chemicals to which the tool will be exposed. In certain embodiments, suitable materials of construction for source collimator 225 and detector collimator 248 include, but are not limited to, heavy-met, lead, dense and very-high atomic number (Z) materials, or any combination thereof.

Further, while a 1 11/16 inch diameter configuration tool is illustrated, the tool 100 can be sized as desired for a particular application. Those skilled in the art will appreciate that a larger diameter tool would allow more detectors and shielding to provide further segmentation of the view of the gravel pack.

This tool may be deployed to measure the integrity of the gravel pack in new installations and to diagnose damage to the gravel pack from continuing production from the well. A person of ordinary skill in the art with the benefit of this disclosure will appreciate how to relate the log results of count rates and inferred densities of gravel pack material to the structure of the pack and to reason from the results to the condition of the pack.

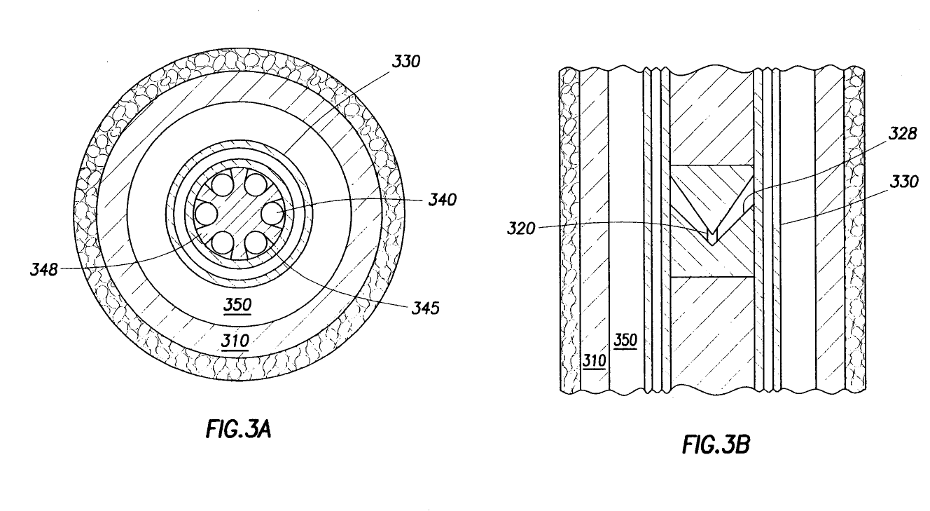

As a further illustration of an exemplary geometry of the embodiment illustrated in FIG. 2, FIGS. 3A and 3B show cross-sectional views of another embodiment of the tool disposed in base pipe or screen 330, which is further disposed in casing 310, which is further disposed in gravel pack 350, where FIG. 3A shows a cross-section taken from the X-Y plane and where FIG. 3B shows a cross-section taken from the X-Z plane. As shown in the illustrated embodiment, source collimator 328 is conical shaped in the X-Z plane or Y-Z plane. Detector 340 is shown in FIG. 3A in openings or slots 345, whereas radiation source 320 is shown depicted in FIG. 3B. As shown in FIG. 3A, detector collimators 348 are fan-shaped in the X-Y plane and rectangular in the X-Z or Y-Z planes. In certain embodiments, a conical source collimator 328 is desirable as it reduces multiple scattering events in the gravel pack.

Methods of using the present invention may include the use of different energy windows to discriminate the gravel pack in low to high density completion fluids. In certain embodiments, at least three energy windows are used where each window depends on the source energy. For example, for a Cs source (662 keV), the Low Energy (LE) window (typically from about 50 keV to about 200 keV) is sensitive to multiple scattered source gamma-rays, whereas the High Energy (HE) window (typically from about 200 keV to about 350 keV) is sensitive to single-scattered source gamma rays. A Broad Window (BW) typically may include gamma rays in the range of about 50 keV to about 350 keV. The BW count rate has the highest statistical precision and is used for the base gravel pack imaging. The LE and HE windows may be used for specific applications, such as deep-reading and maximum-dynamic-range imaging capabilities. Combinations of these different energy window logs can be combined using special methods (e.g. ad-hoc adaptive or Kalman-type processing algorithms) for enhanced precision and resolution. It is recognized that multiple-intensity energy sources may be utilized in the same tool, either simultaneously or sequentially.

In addition to the energy levels of the radiation source, other factors that may be adjusted to discriminate segmented views of the gravel pack include, but are not limited to the angle of the collimators and the source to detector spacing. Examples of suitable angles of the source collimator include, but are not limited to, angles from about 15° to about 85°, and from about 65° to about 85° in other embodiments. Examples of suitable source to detector spacings include, but are not limited to, from about 1 inch to about 3.5 inches to about 8 inches, and in other embodiments, from about 6 inches to about 10 inches, and in still other embodiments to about 12 inches.

Radioactive tracers may be used in conjunction with certain embodiments to produce enhanced images of the gravel pack. The introduction of radioactive tracers allow production of an image of the azimuthally distributed radioactive tracer material. Radioactive tracers may be attached to the gravel pack before building the gravel pack or as the gravel pack is being placed. Alternatively, radioactive tracers may be injected or otherwise introduced into the gravel pack after installation of the gravel pack (e.g. as a fluid or slurry). More generally, radioactive tracers may be introduced into any portion of the formation as well.

Where radioactive tracer material is attached to the gravel itself before placement, void areas show up on the images as low count-rate (or “dark”) regions, whereas where the radioactive tracer material is injected as a fluid or slurry, void areas void areas show up on the images as high count-rate (“bright”) regions within the gravel pack. Further image enhancement may be achieved by using a variety of tracers to create a multiple-isotope log. When used for this purpose, source 320 in FIG. 3, 220 in FIG. 2, or 120 in FIG. 1 may be omitted from the tool. Alternatively, tracer radioactivity may be determined in the presence of the radiation source or multiple tracers can be identified by using the energy discrimination capability of electronics 260.

Moreover, it is recognized that the downhole tool is capable of measuring count rates while being lowered or raised in the wellbore. In certain embodiments, the downhole tool may perform measurements while the tool is stationary in the wellbore. Exemplary raising and lowering rates include displacement rates of up to about 1800 feet/hour.

To facilitate a better understanding of the present invention, the following examples of certain aspects of some embodiments are given. In no way should the following examples be read to limit, or define, the scope of the invention.

### EXAMPLES

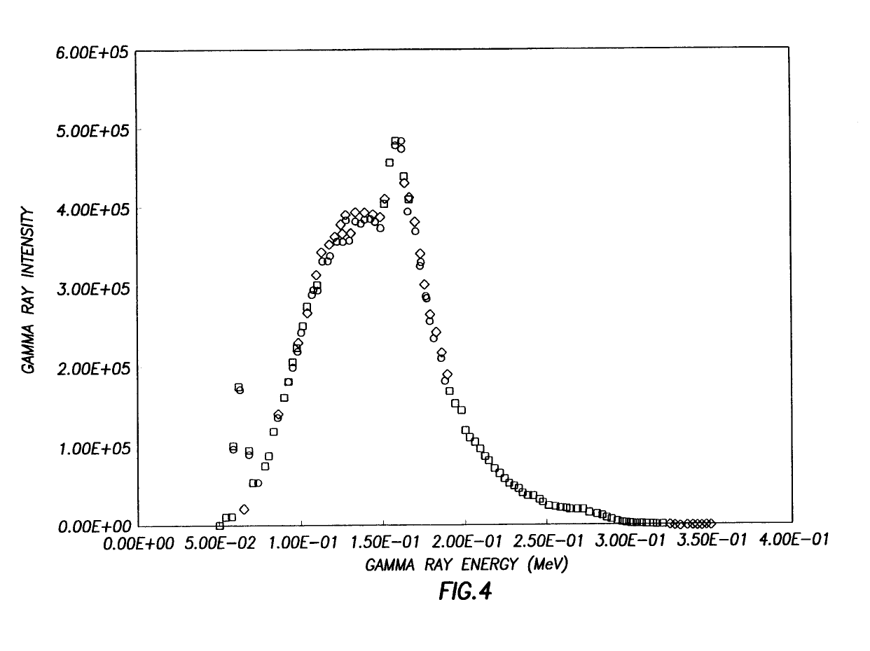

FIG. 4 shows a graph of a spectrum of gamma rays incident on one of the detectors as a response to being scattered in a gravel pack.

Here, typical gamma ray intensity is shown plotted versus gamma ray energy (MeV). This graph shows an MCNP-modeled detector energy spectrum simulation of an actual tool resulting from the ¹³³Ba 356 keV gamma ray Compton back scattered in various gravel pack scenarios. This graph signifies the advantage of choosing a low-energy gamma source. By using an energy source that is low enough, one can ensure that the gravel-pack tool is sensitive primarily to the near-region variations of the gravel pack and not significantly affected by scattering in deeper regions of the cement around the casing or the formation and subsequent formation density variations. However, in cases of thick base pipes and metal screens between the gravel pack and the gravel-pack tool detectors, the source energy must be sufficiently high to penetrate into the gravel-pack screen. In this way, gravel pack imaging tools may be designed to “focus” on particular depths or portions of a gravel pack.

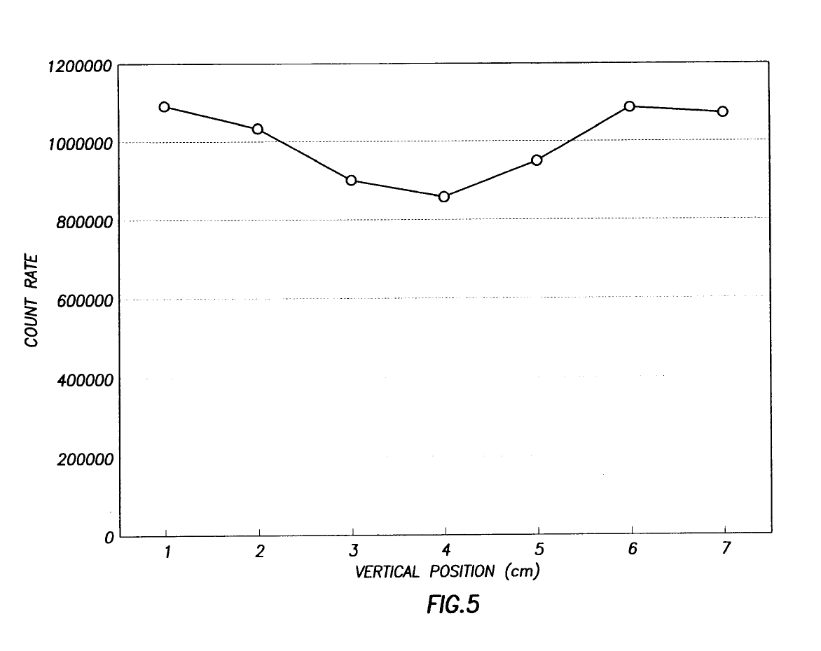

FIG. 5 shows a graph of a count rate versus depth in centimeters as measured by a 3.5″ gravel-pack imaging tool in a 7 inch gravel pack. These logs were produced by processing individual detector gamma-ray count rates. The plot in FIG. 5 is an MCNP-modeled example of the count-rate sensitivity to a 1-inch annulus wash out in a gravel pack centered at a depth index of 4-centimeters. It shows significant sensitivity to changes in the gravel pack density. Qualitative image logs will be produced by displaying the relative count rates from each detector sector at each depth. Another means of analyzing the counts can be used to compute a more quantitative multi-sector density (i.e. in grams/cc) profile. Such a density log can be derived from the count rates by using a calibrated logging count rate-to-density algorithm.

Notably, traditional prior art density tools used to measure the gravel pack generally have a relatively large spacing between the source and the detector. The reason for this is that the tool is provided to evaluate the entire gravel pack. The source and detector are both typically located centrally in the tool along the tool's axis. Shielding may be provided along the axis between the source and the detector to prevent energy coupling between the two, i.e., energy passing directly from the source to the detector without scattering within the gravel pack. In the prior art, because of the relatively large spacing between the source and detector, the gamma ray radiation undergoes significant multiple scattering and absorption before it is detected and counted. The more dense the gravel pack, the fewer counts that are recorded. In other words, in the tools of the prior art, the count rate decreases with gravel pack density because the multiple scattering and absorption attenuates the total amount of radiation measured by the detectors.

In the system of the present invention, the source and the detectors are closely positioned to one another, preferably about 3.5 inches apart. Because of this close physical relationship, energy propagated into the gravel pack and reflected back to the detector undergoes much less scatter, i.e., typically only a single scatter (back to the detector) as opposed to multiple scattering. In fact, the count rates increase with the density of the gravel pack utilizing the tool of the invention. This is significant because this means that the radiation does not undergo the attenuation associated with tools of the prior art.

Moreover, the prior art does not utilize a conically shaped collimator to direct the energy propagated into the gravel pack. Again, by utilizing such a collimator in the prior art tool, multiple scattering can be minimized and improve upon the imaging of the prior art tools.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

What is claimed is:

1. A method for evaluating a gravel pack disposed in a completed wellbore, said method comprising the steps of:
providing a downhole evaluation tool comprising a radiation source, an array of detectors for measuring radiation so as to produce measured radiation data, a source collimator for directionally constraining radiation from the radiation source to a limited segment of the gravel pack, detector shielding for each detector that results in a limited view for each detector to an azimuthal segment of the gravel pack, and electronics communicatively coupled to the array of detectors for receiving the measured radiation data;
raising the downhole evaluation tool in a wellbore;
allowing the radiation source to emit radiation focused on a segment of the gravel pack;
measuring radiation via the detectors to produce measured radiation data; and
analyzing the measured radiation data to assess integrity of the gravel pack.

2. The method of claim 1 wherein the radiation detected is separated into a low energy window, a high energy window, and a broad energy window;
wherein the low energy window is at an energy intensity level of about 50 keV to about 200 keV;
wherein the high energy window is at an energy intensity level of about 200 keV to about 350 keV; and
wherein the broad energy window is at an energy intensity level of about 50 keV to about 350 keV.

3. The method of claim 2 wherein the analyzing step comprises using an ad hoc adaptive or Kalman processing algorithm with respect to count rates for the radiation for enhanced precision and resolution.

4. The method of claim 1 further comprising determining the free point of a stuck pipe from the measured radiation data.

5. The method of claim 1 further comprising introducing a radioactive tracer material into the gravel pack.

6. The method of claim 5 wherein the radioactive tracer material comprises a plurality of radioactive isotopes.

7. The method of claim 1 further comprising the step of providing an orientation module to provide orientation data about an orientation of the tool azimuthally with respect to an orientation of the wellbore, said orientation data to be correlated to an acquisition of counts measured by the radiation detectors.

8. A gravel pack imaging tool for evaluating gravel pack integrity comprising:
a housing;
a radiation source disposed in the housing;
a source collimator disposed adjacent the radiation source;
a detector collimator defined along an axis and disposed in the housing; and
an array of detectors, each detector characterized by a collimated view and each detector mounted spaced apart from one another on said collimator.

9. The gravel pack imaging tool of claim 8 wherein the radiation source comprises a an isotopic gamma ray source.

10. The gravel pack imaging tool of claim 9 wherein the gamma ray source comprises a low energy source with an energy less than about 1 MeV.

11. The gravel pack imaging tool of claim 9 wherein the gamma ray source comprises a radioactive isotope of barium or cesium.

12. The gravel pack imaging tool of claim 8 wherein the detectors comprise a plurality of scintillator crystals coupled to photomultiplier tubes.

13. The gravel pack imaging tool of claim 8 wherein the detectors comprise a plurality of scintillator crystals coupled to a CCD or a micro-channel photo-amplifier.

14. The gravel pack imaging tool of claim 8 wherein the detectors comprise a plurality of scintillator crystals coupled to a light-to-electrical signal conversion device.

15. The gravel pack imaging tool of claim 8 further comprising electronics communicatively coupled to the array of detectors for receiving the measured radiation data and processing said measured radiation data into information about the integrity of the gravel pack.

16. The gravel pack imaging tool of claim 15 wherein the electronics further comprise memory for storing the measured radiation data and processed data.

17. The gravel pack imaging tool of claim 15 further comprising a power supply wherein the power supply comprises a battery for supplying power to the electronics.

18. The gravel pack imaging tool of claim 8 wherein the source collimator is a heavy-met shielding or lead.

19. The gravel pack imaging tool of claim 8 further comprising a shielding between the radiation source and the detectors wherein the shielding is tungsten, lead, or any combination thereof.

20. The gravel pack imaging tool of claim 18 wherein the housing comprises a light metal.

21. The gravel pack imaging tool of claim 18 wherein the housing comprises beryllium; aluminum; titanium; alloys of one or more of beryllium, aluminum, and titanium; a high strength alumina based ceramic, or any combination thereof.

22. The gravel pack imaging tool of claim 8 where the detector collimator has a plurality of openings each of which is characterized by an aperture size, and wherein a detector is mounted in each opening so that the aperture size limits the radiation received by the detector disposed therein.

23. The gravel pack imaging tool of claim 22 wherein the detector collimator is adapted to limit radiation received by each detector to about no more than about 360 degrees divided by the number of detectors.

24. The gravel pack imaging tool of claim 22 wherein the detector collimator is adapted to limit radiation received by each detector to about 360 degrees divided by the number of detectors.

25. The gravel pack imaging tool of claim 22 wherein the detector collimator is adapted to limit radiation received by each detector to substantially less than about 360 degrees divided by the number of detectors.

26. The gravel pack imaging tool of claim 16 wherein the processor mitigates the effects of multiple-detected gamma rays, caused by detector-to-detector scattering, by implementation of an anti-coincidence algorithm.

27. The gravel pack imaging tool of claim 22 where the openings are elongated slots.

28. The gravel pack imaging tool of claim 8 further comprising an orientation sensor communicatively coupled to the electronics.

29. The gravel pack imaging tool of claim 8 wherein the radiation source is adapted to emit radiation at multiple energy levels.

30. The gravel pack imaging tool of claim 8 further comprising a plurality of radiation sources wherein each radiation source is adapted to emit radiation at different energy levels.

31. The gravel pack imaging tool of claim 20 wherein the detector is adapted to detect radiation at energies from about 50 keV to about 350 keV.

32. The gravel pack imaging tool of claim 20 wherein the detector is adapted to detect radiation at energies from about 50 keV to about 200 keV.

33. The gravel pack imaging tool of claim 8 wherein gravel pack imaging tool is adapted to detect gravel pack integrity within about 3 inches of a gravel pack screen.

34. The gravel pack imaging tool of claim 8:
wherein the housing comprises an elongated, tubular housing having an outer surface, said housing defined along an axis and further having a first radius extending to the outer surface;
wherein the radiation source comprises a low energy radiation source positioned in said housing along said axis;
wherein the array of detectors comprise at least two radiation detectors disposed within said housing, each detector disposed within said housing on a radius smaller than the first radius; and
wherein the gravel pack imaging tool further comprises radiation shielding disposed between said detectors.

35. The gravel pack imaging tool of claim 34 wherein said radiation shielding comprises a hollow cylindrical shield of radiation absorbing material, and wherein said shaft has at least two apertures therein and wherein a radiation detector is disposed in each aperture.

36. The gravel pack imaging tool of claim 34 wherein said radiation detectors comprise scintillator crystals.

37. The gravel pack imaging tool of claim 34 wherein said radiation shielding is further disposed along said axis between said radiation source and said detectors.

38. The gravel pack imaging tool of claim 37 wherein at least part of the radiation shielding between said source and detectors is conically shaped adjacent said radiation source.

39. The gravel pack imaging tool of claim 38 further comprising outwardly extending radial plates adjacent said radiation source.

40. The gravel pack imaging tool of claim 35 wherein said shaft is round and solid.

41. The gravel pack imaging tool of claim 35 wherein said shaft is coaxially positioned in said housing.

42. The gravel pack imaging tool of claim 41 wherein each slot is elongated and extends parallel to the axis of said tubular member.

43. The gravel pack imaging tool of claim 34 comprising at least 3 detectors.

44. The gravel pack imaging tool of claim 34 comprising 6 detectors but no more than 12 detectors.

45. The gravel pack imaging tool of claim 36 wherein said scintillator crystal is of an elongated, round shape.

46. The gravel pack imaging tool of claim 34 wherein the energy source is capable of propagating energy no farther than about 12 inches from the source.

47. The gravel pack imaging tool of claim 34 wherein said detectors are positioned the same distance away from the radiation source.

48. The gravel pack imaging tool of claim 34 wherein said detectors are no more than about 8 inches from the radiation source.

49. The gravel pack imaging tool of claim 34 wherein said detectors are positioned different distances away from the radiation source.

50. The gravel pack imaging tool of claim 34 wherein the detectors are positioned on the same radius as one another.

51. The gravel pack imaging tool of claim 50 wherein the detectors are equally spaced from one another on said same radius.

52. The gravel pack imaging tool of claim 34 wherein at least one detector array is positioned on either side of the radiation source.

53. The gravel pack imaging tool of claim 34 further comprising an orientation module wherein the orientation module comprises one or more inclinometers.

54. A method for measuring the density of a portion of the gravel pack adjacent a tool, said method comprising the step of propagating energy into the gravel pack adjacent the tool, detecting energy reflected back to the tool from the gravel pack and measuring the density of the gravel pack based on count rates of the detected energy, wherein the count rates increase with the density of the gravel pack.

55. A gravel pack imaging tool for evaluating gravel pack integrity comprising:
a housing;
a radiation source disposed in the housing;
a source collimator disposed adjacent the radiation source wherein said source collimator is conical in shape; and
a detector disposed in the housing said detector mounted spaced apart from said source.
